(19) United States
(12) Patent Application Publication
(10) Pub. No.: US 2009/0116173 A1
(43) Pub. Date: May 7, 2009

(54) Solid electrolytic capacitor

(75) Inventors: Kunihiko Shimizu, Sendai-shi (JP); Kazuyuki Katoh, Sendai-shi (JP); Katsuhiro Yoshida, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 11/973,946

(22) Filed: Oct. 11, 2007

(30) Foreign Application Priority Data
Oct. 12, 2006 (JP) 2006-278420

(51) Int. Cl. H01G 9/15; H01G 9/042

(52) U.S. Cl. 361/529; 361/523

(57) ABSTRACT

A solid electrolytic capacitor according to this invention includes a capacitor element with a drawn-out anode lead, a conversion substrate mounted with the capacitor element, and a casing resin covering the capacitor element mounted on the conversion substrate. The conversion substrate has, on one surface thereof, a connection pattern composed of an anode portion connected to the anode lead and a cathode portion connected to the body of the capacitor element. The conversion substrate further has, on another surface thereof on the side opposite to the foregoing one surface, a terminal pattern composed of an anode terminal and a cathode terminal connected to the anode portion and the cathode portion through the conversion substrate, respectively. The terminal pattern differs from the connection pattern.

This application is based upon and claims the benefit of priority from Japanese Patent Application No. 2006-278420, filed on Oct. 12, 2006, the disclosure of which is incorporated herein in its entirety by reference.

### BACKGROUND OF THE INVENTION

This invention relates to a solid electrolytic capacitor having a plurality of mounting electrodes, for use mainly in power supply circuits of various devices in the electric/electronic/communication fields.

### BACKGROUND ART

In recent years, a reduction in size and thickness and an increase in functionality of electronic devices have been advanced. As one of effective techniques for realizing it, an increase in circuit driving frequency is cited. To cope with this, a reduction in equivalent series inductance (hereinafter referred to as ESL) and an increase in capacitance are becoming a major subject in solid electrolytic capacitors.

As regards the increase in capacitance, it becomes important how to reduce the volume occupied by electrodes and a casing material, other than a capacitor element contributing to the capacitance, in a capacitor, thereby achieving a structure that can increase the volume of the capacitor element.

A conventional solid electrolytic capacitor includes a capacitor element having an anode lead and formed with a solid electrolyte layer and a cathode layer. The capacitor element is connected to a lead frame and covered with a casing resin and the lead frame drawn out from the casing resin is used as electrodes.

As a means for improving the volume efficiency, Japanese Unexamined Patent Application Publication (JP-A) No. 2002-110459 (Patent Document 1) discloses a solid electrolytic capacitor as shown in FIG. 1. Referring to FIG. 1, this solid electrolytic capacitor comprises a capacitor element 2 having a drawn-out lead 1 and formed with a dielectric oxide coating, a solid electrolyte layer, and a cathode lead layer, an electrode substrate 7 serving as electrodes of the capacitor, and a casing resin 9. The electrode substrate 7 comprises an insulating layer 4 having at least two through holes, conductive plates 3, 3 provided on one surface of the insulating layer 4 so as to cover the through holes, and electrode layers 10, 10 formed so as to fill the inside of the through holes. The electrode substrate 7 further comprises plating layers 6a, 6b and 6c, 6d on the conductive plates 3, 3 and in the through holes, respectively, and the plating layers 6b, 6d in the through holes are in contact with the electrode layers 10, 10. This solid electrolytic capacitor is fabricated by resistance-welding together a metal strip 5 plated with matte tin on the surface and the drawn-out lead 1, electrically connecting the metal strip 5 and the plating layer 6a to each other and the capacitor element 2 and the plating layer 6c to each other using a conductive adhesive 8, and then covering the capacitor element 2 with the casing resin 9.

As is clear from FIG. 1, the electrode substrate 7 serving as the electrodes of the capacitor is configured to have the insulating layer 4 with the through holes, the conductive plates 3, and the electrode layers 10. However, there is no detailed description about the outer side of the electrode substrate 7 (hereinafter sometimes referred to as the capacitor mounting electrode surface) serving as the bottom surface of the capacitor.

As the cause of increasing the ESL, there are the magnetic permeabilities of conductors inside a capacitor, the wiring lengths/wiring shapes from the inside of the capacitor to mounting terminals, and so on. To cope with this, a technique has been widely employed in recent years that shortens the distance between anode and cathode mounting terminals to thereby reduce an inductance component, called a loop inductance, generated between the anode and cathode mounting terminals and, further, increases the number of the mounting terminals so as to alternately arrange the anode and cathode mounting terminals one-dimensionally or two-dimensionally. Hereinafter, a capacitor having a plurality of mounting terminals for the purpose of reducing the ESL will be referred to as a multi-terminal capacitor.

As an example of the former of the foregoing techniques, there is a laminated ceramic capacitor of the type called IDC (Inter-Digitated Capacitors) and, as an example of the latter, there is a laminated ceramic capacitor of the type called LICA (Low Inductance Capacitor Arrays). On the other hand, as an electrolytic capacitor, there is a multi-terminal capacitor, for example, disclosed in Patent Document 2 (Japanese Unexamined Patent Application Publication (JP-A) No. 2002-343686) or the like. Although a laminated ceramic capacitor type device and a solid electrolytic capacitor type device differ in basic structure, the solid electrolytic capacitor type device will be described herein.

FIG. 2 shows, in a perspective view including a section, the basic structure of a solid electrolytic capacitor type multi-terminal capacitor disclosed in Patent Document 2.

In the case of the multi-terminal type solid electrolytic capacitor shown in FIG. 2, a reduction in ESL is achieved by alternately arranging first electrode terminals (anode terminals) 12 and second electrode terminals (cathode terminals) 13. For alternately arranging the anode terminals and the cathode terminals, each of the second electrode terminals (cathode terminals) 13 is connected to a solid electrolyte layer 17 and a collector layer 18 of an element portion by providing an insulator 15 in a valve metal sheet body 11 and in a porous portion after formation of the solid electrolyte layer 17, then forming a through hole 22 in the insulator 15, and then filling the inside thereof with a conductor 16. On the other hand, the first electrode terminals (anode terminals) 12 are configured so as to be directly formed on the base-material valve metal sheet body 11. 14 denotes an insulating layer. In the case of this capacitor structure, the loop inductance of the entire product decreases as the distance between the anode and cathode mounting terminals is shortened and the ESL decreases as the number of the terminals is increased.

### SUMMARY OF THE INVENTION

In the case of manufacturing a solid electrolytic capacitor using a conventional lead frame, a connecting surface, with a capacitor element, of each of an anode terminal portion and a cathode terminal portion (hereinafter sometimes referred to as a capacitor element connecting surface) and a capacitor mounting electrode surface thereof have the same shape as each other. Therefore, there has been a problem that it is difficult to change the electrical connection area of an upper surface/lower surface of the terminal portion and, thus, when the capacitance element body serving as a cathode portion is made large, a structural or chemical insulating treatment is required for preventing contact with the anode terminal portion.

Although there is no detailed description about the capacitor mounting electrode surface in Patent Document 1 disclosing the solid electrolytic capacitor improved in volume efficiency, when surface-mounting such an electronic component having the mounting electrodes of one cathode and one anode, there arises a problem such that there is no symmetric property and, when the electrode surface is narrow, there tends to occur the Manhattan phenomenon (component rise) or the like in which the self-alignment property is difficult to achieve in solder reflow mounting. Conversely, with respect to the shapes of capacitor element connecting surfaces, if a capacitor element is made larger for increasing the capacitor capacitance, since a solid electrolyte layer portion serving as a cathode portion increases in size relative to an anode portion, it is preferable that the anode portion and the cathode portion have different structures. Further, in Patent Document 1, there is also no description about a multi-terminal structure with three or more terminals.

On the other hand, in the case of the multi-terminal type solid electrolytic capacitor disclosed in Patent Document 2, each of the through holes 22 penetrating the element portion as shown in FIG. 2 is formed in the following manner. An opening hole is formed in the porous portion being the feature of the electrolytic capacitor and in the valve metal sheet body 11 and then an insulating resin is filled in the opening hole as the insulator 15. After the insulating resin portion is cured, an opening hole having a size not exceeding the diameter of the initial opening hole is formed at the center of the insulating resin portion and the inside of the opening hole is covered/filled with the conductor 16 such as plating, thereby forming the through hole 22. However, the leakage current characteristics of the product are often degraded due to occurrence of cracks at the insulating resin portions or damage to the capacitor element including the porous portion around the opening holes, caused by mechanical/thermal stresses in the formation of the second opening holes. Further, there is a problem that if the number of the through holes 22 is increased, the ESL decreases, but the area of the portion contributing to the capacitance of the capacitor also decreases simultaneously, so that the capacitance of the capacitor decreases. Further, a valve metal used as the valve metal sheet body 11 tends to be subjected to natural formation of a gas-phase oxide coating. Since electrode formation by plating becomes difficult if the oxide coating is formed, it is difficult to use a plating method for forming the first electrode terminals (anode terminals) 12. Even if the plating method is forcibly applied thereto, it is not easy to form long-term reliable electrical connecting portions between the first electrode terminals (anode terminals) 12 and the valve metal sheet body 11. For this reason, in an electrolytic capacitor using aluminum, tantalum, or niobium, welding such as resistance welding or ultrasonic welding is normally used for connection between anode terminals and a valve metal sheet body. However, there is a difficulty in the manufacturing aspect that welding a number of small-diameter anode terminals requires a very high degree of technical difficulty and is thus unsuitable for mass production.

As described above, in the case of the well-known solid electrolytic capacitor represented by Patent Document 2, although the terminal structure is examined for the purpose of reducing the ESL, there is a problem that the mass production is practically difficult due to the reason such as the damage to the capacitor element in the formation of the through holes 22 or the difficulty in connection between the first electrode terminals (anode terminals) 12 and the valve metal sheet body 11, i.e. it cannot be easily manufactured. Therefore, there has been a problem that it is necessary to thoroughly change the processes from the capacitor element forming process in order to change the electrical characteristics, thus being inferior in mass productivity.

In view of the foregoing problems, it is an object of this invention to provide a solid electrolytic capacitor that enables an increase in capacitance, that is excellent in mass productivity, further, that has a low ESL, and that is excellent in mountability.

A solid electrolytic capacitor according to this invention comprises a capacitor element with a drawn-out anode lead, a substrate mounted with the capacitor element, and a casing resin covering the capacitor element mounted on the substrate. The substrate has, on one surface thereof, a connection pattern comprising an anode portion connected to the anode lead and a cathode portion connected to a body of the capacitor element and has, on another surface thereof on a side opposite to the one surface, a terminal pattern comprising an anode terminal and a cathode terminal connected to the anode portion and the cathode portion through the substrate, respectively. The terminal pattern is different from the connection pattern.

In the solid electrolytic capacitor according to this invention, is is desirable that the capacitor element comprises a porous anode body with the drawn-out anode lead, formed by molding and sintering a powder of a valve metal, a dielectric layer formed on the anode body by anodic oxidation, and a solid electrolyte layer formed on the dielectric layer.

In the solid electrolytic capacitor according to this invention, it is also desirable that the number of the anode and cathode terminals provided on the other surface is at least three.

In the solid electrolytic capacitor according to this invention, it is further desirable that the anode and cathode terminals are arranged in point symmetry with respect to a center point of the another surface.

In the solid electrolytic capacitor according to this invention, it is further desirable that the substrate is made of a glass-containing epoxy resin or a liquid crystal polymer and the anode portion and the cathode portion on the one surface are electrically connected to the anode terminal and the cathode terminal on the another surface by through holes, respectively.

In the solid electrolytic capacitor according to this invention, it is further desirable that the valve metal is tantalum or niobium.

In the solid electrolytic capacitor according to this invention, it is further desirable that a metal piece is connected to the anode lead, and the metal piece and the body of the capacitor element are connected to the anode portion and the cathode portion through a conductive adhesive, respectively.

In this invention, a connection pattern comprising an anode portion and a cathode portion is formed on one surface of a substrate, i.e. on a capacitor element connecting surface, and then a capacitor element is mounted. Thus, the area of the cathode portion on the capacitor element connecting surface can be increased to thereby facilitate an increase in capacitance, so that it is possible to obtain a solid electrolytic capacitor excellent in mountability and mass productivity while being small in size and large in capacitance. Further, by providing three or more anode and cathode terminals on the other surface of the substrate, i.e. on a capacitor mounting electrode surface, it is possible to achieve a reduction in ESL as compared with the conventional two-terminal electrode structure. Further, by arranging the three or more anode and cathode terminals on the capacitor mounting electrode surface in point symmetry with respect to the center of the capacitor mounting electrode surface, even if there is the polarity (distinction between anode and cathode) of a capacitor caused by the rectification characteristics peculiar to a solid electrolytic capacitor, the capacitor can be mounted even in a state where the direction of the longitudinal axis of the capacitor is rotated by 180 degrees. Accordingly, it is possible to obtain a solid electrolytic capacitor excellent in mountability by preventing reverse mounting failure where the positions of an anode and a cathode are mistaken for each other, particularly in the case of the reduced size.

### BRIEF DESCRIPTION OF THE DRAWINGS

FIG. 1 is a sectional view showing an example of a conventional solid electrolytic capacitor,

FIG. 2 is a diagram showing, in a perspective view including a section, a conventional solid electrolytic capacitor type multi-terminal capacitor,

FIG. 3 is a sectional view of a solid electrolytic capacitor according to an embodiment of this invention,

FIG. 4A is a sectional view of a conversion substrate with six terminals for use in a solid electrolytic capacitor according to an embodiment of this invention,

FIG. 4B is a sectional view of a conversion substrate with four terminals for use in a solid electrolytic capacitor according to an embodiment of this invention,

FIG. 5A is a diagram for explaining a mounting electrode surface of a conversion substrate with four terminals for use in a solid electrolytic capacitor according to an embodiment of this invention,

FIG. 5B is a diagram for explaining a mounting electrode surface of a conversion substrate with six terminals for use in a solid electrolytic capacitor according to an embodiment of this invention,

FIG. 5C is a diagram for explaining a mounting electrode surface of a conversion substrate with six terminals for use in a solid electrolytic capacitor according to an embodiment of this invention,

FIG. 5D is a diagram showing a conversion substrate for use in a solid electrolytic capacitor according to an embodiment of this invention, wherein the conversion substrate has four terminals arranged in point symmetry with respect to the center point of a mounting electrode surface of the conversion substrate,

FIG. 5E is a diagram showing a conversion substrate for use in a solid electrolytic capacitor according to an embodiment of this invention, wherein the conversion substrate has nine terminals arranged in point symmetry with respect to the center point of a mounting electrode surface of the conversion substrate,

FIG. 6A is a sectional view showing an internal structure of a capacitor element, and

FIG. 6B is a sectional view enlargedly showing a portion A in FIG. 6A.

### DESCRIPTION OF THE EXEMPLIFIED EMBODIMENT

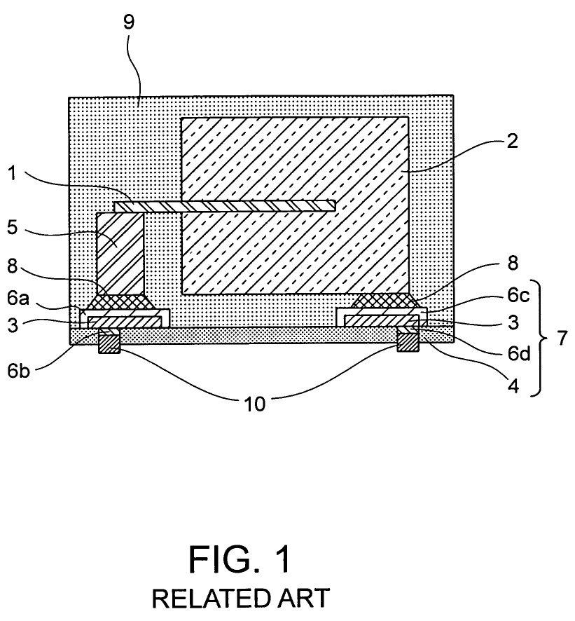

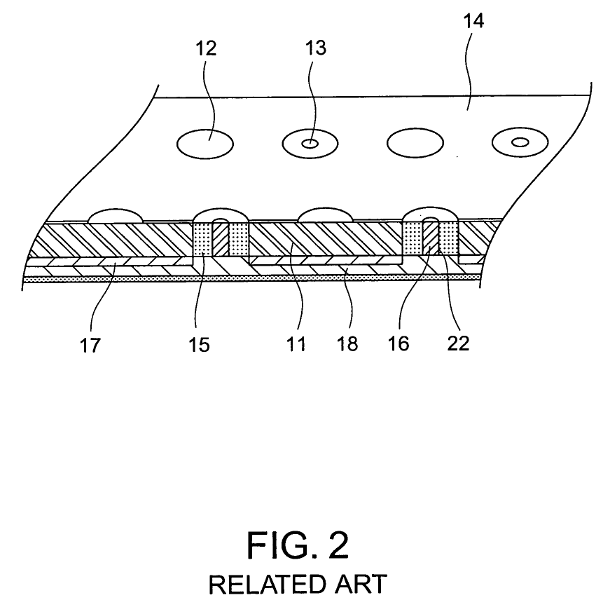

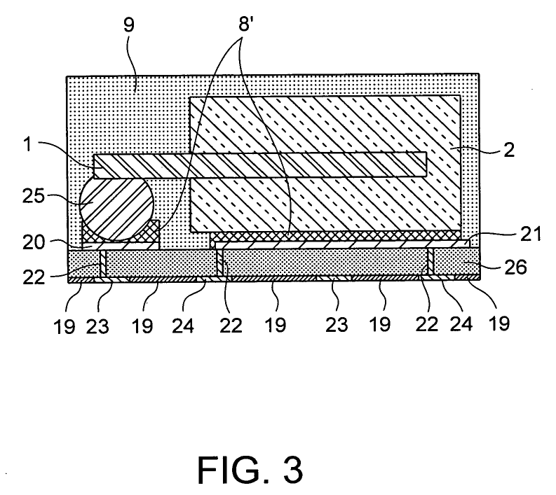

FIG. 3 is a sectional view for explaining a solid electrolytic capacitor according to an embodiment of this invention. For convenience' sake, the same numerals are assigned to the same portions as those of the solid electrolytic capacitor shown in FIG. 1. An anode material of the solid electrolytic capacitor according to this invention may be any material as long as it is a valve metal that forms an anodized coating serving as a dielectric layer by anodic oxidation, while, a description will be given of, as an example, a tantalum solid electrolytic capacitor using a tantalum metal, which can be easily increased in capacitance by enlarging the surface area with porous powder. A manufacturing method of a capacitor element will be briefly described because of it being a known technique. The shape of the capacitor element, the shape of an anode lead and its drawn-out position, and so on are not particularly limited.

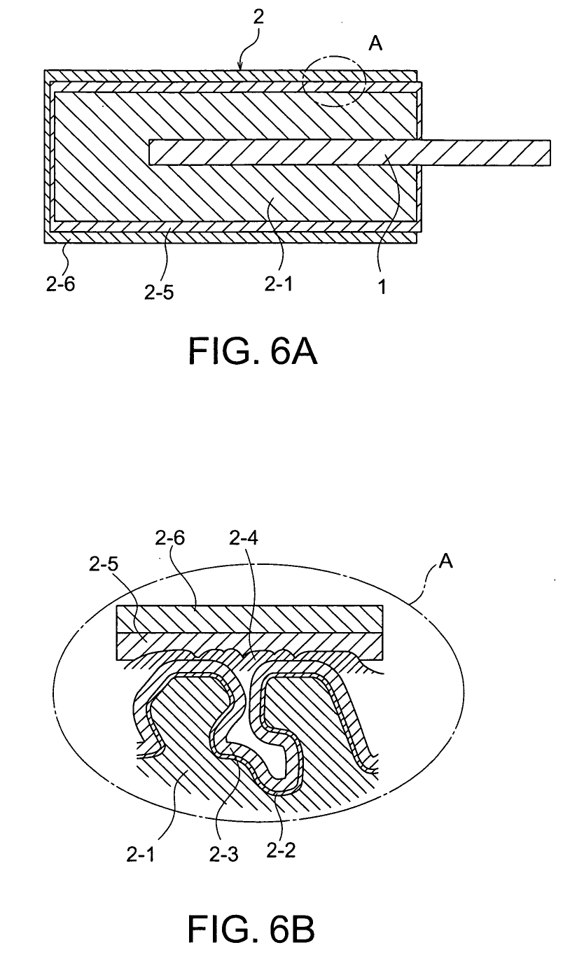

A capacitor element 2 is formed in the following manner. Referring also to FIGS. 6A and 6B, a porous compact made of tantalum metal powder and having a drawn-out anode lead 1 in the form of a tantalum line serving as an anode drawn-out portion of the capacitor element 2 is heat-treated in a high vacuum at a high temperature so as to be formed into a sintered body (anode body 2-1) while maintaining the porosity according to the known technique. Thereafter, the sintered body is immersed in an electrolyte solution and subjected to anodic oxidation at an arbitrary anodization voltage, thereby forming Ta₂O₅ being an oxide coating serving as a dielectric layer 2-2 on the tantalum metal surface. Then, a solid electrolyte layer 2-3 is formed on the dielectric oxide coating. The solid electrolyte layer may be formed of a conductive polymer (polymer layer 2-4) obtained by polymerizing a thiophene monomer, a pyrrole monomer, or a derivative monomer thereof or may be formed of manganese dioxide obtained by thermally decomposing manganese nitrate. On the layer thus formed, cathode layers of graphite paste (graphite layer 2-5) and silver paste (silver layer 2-6) are formed in order, thereby completing the capacitor element 2.

Then, the anode lead 1 and a metal piece 25 are connected together by resistance welding. A 42 alloy, copper, or the like is cited as a material of the metal piece 25. A cathode portion 21 and an anode portion 20 serving as capacitor element connecting surfaces are respectively formed on a flat-plate conversion substrate 26. Then, the capacitor element 2 and the metal piece 25 are electrically connected to and fixed to the cathode portion 21 and the anode portion 20, respectively, using a conductive adhesive 8′ so that the body of the capacitor element 2 formed with the silver paste serves as a cathode and the metal piece 25 serves as an anode. The cathode portion 21 has an extending length substantially equal to the entire length of the body of the capacitor element 2. Thereafter, a casing is formed using, as a casing resin 9, a glass-containing epoxy resin, a liquid crystal polymer, a transfer mold resin, or a liquid epoxy resin. In this event, it may be arranged that, after individually carrying out molding using the casing resin 9, aging is performed with the application of a voltage and then, after inspection/selection of characteristic defective products, the conversion substrate 26 is cut, thereby obtaining individual capacitors. Alternatively, it may be arranged that, after thermally molding a casing material in a flat-plate shape on a mass-production substrate in the form of joined conversion substrates mounted with capacitor elements, aging is performed with the application of a voltage and then, after inspection/selection of characteristic defective products, the casing resin 9 and the conversion substrate 26 are cut according to the design size, thereby obtaining individual capacitors.

The solid electrolytic capacitor can be fabricated by the foregoing manufacturing method.

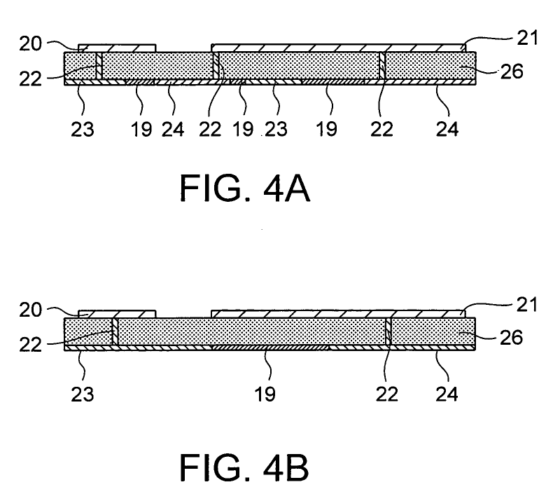

FIGS. 4A and 4B are sectional views of conversion substrates each for use in a solid electrolytic capacitor according to an embodiment of this invention, wherein FIG. 4A is a sectional view of a conversion substrate having six terminals and FIG. 4B is a sectional view of a conversion substrate having four terminals.

As shown in FIGS. 4A and 4B, one surface (herein, an upper surface) of a conversion substrate 26 made of an insulating glass-containing epoxy resin or liquid crystal polymer or the like is given as a capacitor element connecting surface and another surface (herein, a lower surface) on the side opposite to the one surface is given as a capacitor mounting electrode surface. The capacitor element connecting surface of the conversion substrate 26 is provided with a connection pattern comprising an anode portion 20 and a cathode portion 21 for connection to a capacitor element 2. The surface on the side opposite to the capacitor element connecting surface of the conversion substrate 26 is the capacitor mounting electrode surface having a terminal pattern comprising anode terminals 23 and cathode terminals 24. Conductors such as through holes 22 or via holes are formed in the conversion substrate 26 at positions corresponding to intermediate positions of the anode portion 20 and the cathode portion 21, thereby establishing electrical connection between the anode portion 20 and the cathode portion 21 on the capacitor element connecting surface and the anode terminals 23 and the cathode terminals 24 on the capacitor mounting electrode surface, respectively. Although the sectional view of FIG. 4A shows four terminals, i.e. two anode terminals 23 and two cathode terminals 24, an anode terminal and a cathode terminal are provided at another two positions that are offset from this section. Likewise, although FIG. 4B shows two terminals, i.e. one anode terminal 23 and one cathode terminal 24, an anode terminal and a cathode terminal are provided at another two positions that are offset from this section. The multi-terminal structure is preferable for the capacitor mounting electrode surface and insulator portions with an insulating material such as a solder resist layer 19 may be formed at those portions that require insulation for achieving a desired shape.

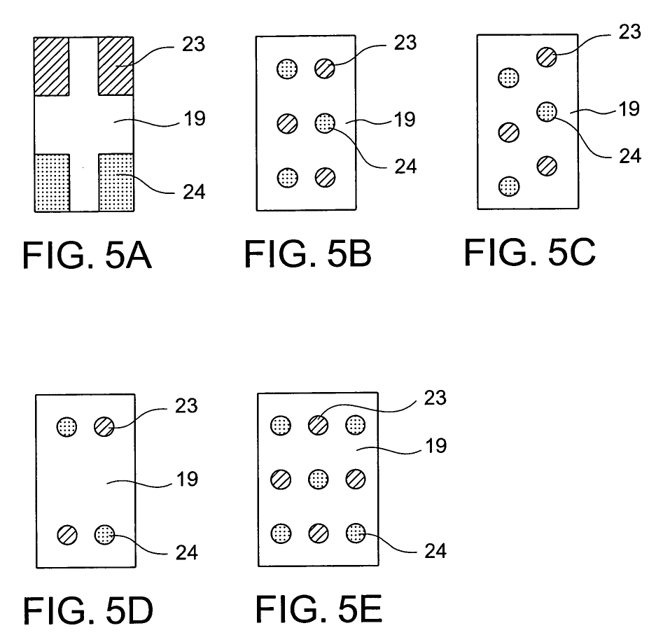

FIGS. 5A to 5E are diagrams for explaining examples of capacitor mounting electrode surfaces of conversion substrates each for use in a solid electrolytic capacitor according to an embodiment of this invention. FIG. 5A shows a conversion substrate having four terminals and FIGS. 5B and 5C each show a conversion substrate having six terminals. On the other hand, FIG. 5D shows a conversion substrate having four terminals arranged in point symmetry with respect to the center point of a capacitor mounting electrode surface of the conversion substrate and FIG. 5E shows a conversion substrate having nine terminals arranged in point symmetry with respect to the center point of a capacitor mounting electrode surface of the conversion substrate. As shown in FIG. 5A, 5B, or 5C, the terminal (electrode) pattern of the capacitor mounting electrode surface of the conversion substrate has the four-terminal structure, the six-terminal structure, or the like. The terminal shape is not particularly limited and may have any configuration as long as it is suitable for mounting on a mounting board. Further, by employing the point-symmetrical four-terminal or nine-terminal structure as shown in FIG. 5D or 5E, even if mounted in a state rotated by 180 degrees, there arises no problem of reverse mounting otherwise caused by rectification peculiar to an electrolytic capacitor and thus the mounting can be facilitated.

What is claimed is:

1. A solid electrolytic capacitor characterized by comprising:
a capacitor element with a drawn-out anode lead;
a substrate mounted with said capacitor element; and
a casing resin covering said capacitor element mounted on said substrate;
wherein said substrate has, on one surface thereof, a connection pattern comprising an anode portion connected to said anode lead and a cathode portion connected to a body of said capacitor element and has, on another surface thereof on a side opposite to said one surface, a terminal pattern comprising an anode terminal and a cathode terminal connected to said anode portion and said cathode portion through said substrate, respectively, said terminal pattern being different from said connection pattern.

2. The solid electrolytic capacitor according to claim 1, characterized in that said capacitor element comprises a porous anode body with said drawn-out anode lead, formed by molding and sintering a powder of a valve metal, a dielectric layer formed on said anode body by anodic oxidation, and a solid electrolyte layer formed on said dielectric layer.

3. The solid electrolytic capacitor according to claim 1, characterized in that the number of said anode and cathode terminals provided on said another surface is at least three.

4. The solid electrolytic capacitor according to claim 3, characterized in that said anode and cathode terminals are arranged in point symmetry with respect to a center point of said another surface.

5. The solid electrolytic capacitor according to claim 1, characterized in that said substrate is made of a glass-containing epoxy resin or a liquid crystal polymer and said anode portion and said cathode portion on said one surface are electrically connected to said anode terminal and said cathode terminal on said another surface by through holes, respectively.

6. The solid electrolytic capacitor according to claim 1, characterized in that said valve metal is tantalum or niobium.

7. The solid electrolytic capacitor according to claim 1, characterized in that a metal piece is connected to said anode lead, and said metal piece and the body of said capacitor element are connected to said anode portion and said cathode portion through a conductive adhesive, respectively.
